(19) United States
(12) Patent Application Publication
(10) Pub. No.: US 2026/0270143 A1
(43) Pub. Date: Sep. 10, 2026

(54) AI-BASED CANARY JUDGE FOR CLOUD RAN

(71) Applicant: Telefonaktiebolaget LM Ericsson (publ), Stockholm (SE)

(72) Inventors: Medhat ELSAYED, Gatineau (CA); Ahmed A. IBRAHIM, Ottawa (CA); Majid BAVAND, Ottawa (CA); Qinan QI, Saint-Laurent (CA); Hakimeh PURMEHDI, Saint-Laurent (CA); Sandeep KUMAR REDDY KADAPA, Ottawa (CA)

(73) Assignee: Telefonaktiebolaget LM Ericsson (publ), Stockholm (SE)

(21) Appl. No.: 19/165,581

(22) PCT Filed: Mar. 20, 2023
(86) PCT No.: PCT/IB2023/052724

§ 371 Date: Sep. 15, 2025

(51) Int. Cl. H04L 41/0813; G06N 3/0455; H04L 43/04

(52) U.S. Cl. CPC H04L 41/0813; G06N 3/0455; H04L 43/04

(57) ABSTRACT

A management node for a wireless communication network including a plurality of network nodes is provided. The management node is configured to train a machine learning model using an historical dataset of performance metrics associated with at least one network node configured with at least one software version of a plurality of software versions and with a non-anomalous state of the at least one network node. The management node is configured to receive a first dataset of performance metrics associated with a first network node configured with a second software version of the software versions which is an update of a first software version of the software versions, and performs a first anomaly detection on the first dataset of performance metrics using the trained machine learning model to determine a number of anomalies of the first dataset of performance metrics.

### TECHNICAL FIELD

The present disclosure relates to wireless communications, and in particular, to configurations for supporting artificial intelligence (AI)-based canary deployment in cloud-based radio access networks (RANs).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Some existing systems, such as cellular networks, employ Cloud Radio Access Network (RAN) architectures, which may allow connections between baseband pool and remote radio heads to be implemented in a scalable manner. Furthermore, Cloud RAN architectures may provide real-time virtualization capability based on open platforms.

Cloud RAN, which may also be known as Virtual RAN (vRAN), Next Generation-RAN (NG-RAN), etc., may refer to a virtual infrastructure which may provide one or more of the following features: (1) delivering legacy RAN benefits and/or alleviating core network signaling overhead (e.g., keep the mobility signaling in the RAN); and (2) delivering cloud benefits (e.g., resource pooling, improved reliability with geo-redundancy, etc.), together with reducing capital expenditure (CAPEX) and operational expenditure (OPEX), enabling multi-tenants, resiliency, deterministic computing performance, as well as, potentially providing a ground for new business models. For example, a Cloud RAN architecture may include a flexible scheme which places at least some of the entities of the random access network (RAN), which have been traditionally placed at the antenna site, in the cloud, and which may enable collaboration between such entities.

Performance metrics (PMs) in a cloud RAN may represent a set of collected metrics to measure the performance of the network, e.g., throughput, latency, core utilization, success rate, etc., associated with one or more network nodes, wireless devices, etc., of the network.

Anomaly detection may refer to a process for identifying anomalies (e.g., errors, unexpected values, etc.), for example, in an input sequence.

A network node, such as a gNB, may be considered a logical representation of a cellular base station, for example. The realization of a network node (e.g., gNB) may differ according to the cellular architecture, for example. In embodiments of the present disclosure, a network node (e.g., gNB) may be used in the context of a cloud RAN architecture, e.g., which may correspond to one or more of distributed units (DUs), centralized units (CUs), and/or virtual distributed units (VDUs).

“Canary” deployment is a process for rolling out software releases to a subset of users, nodes, entities, etc. (e.g., prior to rolling out the software release to all of the users/nodes/entities/etc.). The software may be released to a subset of users for testing purposes, and then a full release to all users may be performed, e.g., if the test passes. In case of failure(s), a roll back process may be triggered to return the system to the previous stable software release.

In some existing systems (e.g., telecom systems), testing may include a vendor performing system testing in vendor premises while the customer performs various stages of testing before equipment is deployed for full operation. A telecom testing process, for example, may involve the inspection of various PMs and Key Performance Indicators (KPIs) over an extended duration. The increased complexity of telecom solutions has made it very challenging to replicate all scenarios that may occur in a live, operational telecom system in customer premises. Therefore, the manual testing of telecom systems may requires extensive effort in addition to well-trained labor with domain knowledge expertise.

In case of canary failure of RAN software, the tester (or an automated rolling framework) must roll back the system to the previous stable release, which may pose difficult, tight timing requirements for maintaining network connectivity and reliability.

Thus, existing systems may lack suitable configurations for supporting Canary deployment, such as automated Canary deployment, for cloud RAN architectures.

### SUMMARY

Some embodiments advantageously provide methods, systems, and apparatuses for AI-based canary judge processes for a canary deployment process in a Radio Access Network (RAN), such as a cloud RAN.

Embodiments of the present disclosure may provide configurations for supporting an AI-based canary judge process for a canary deployment process in a RAN, such as a cloud RAN. Embodiments of the present disclosure may perform a canary judge process, e.g., for identifying faults in the operation of a new software release, such that a deployment success or failure may be triggered.

For example, in some embodiments, the canary judge process may include performing an anomaly detection to identify abnormal and/or erroneous and/or anomalous behavior in a new software release, such as a software version update, a firmware version update, a configuration update, etc.

Embodiments of the present disclosure may include or utilize one or more of a Long Short-term Memory (LSTM) autoencoder, an LSTM forecaster, a Bootstrap technique, and an ensemble technique (e.g., utilizing an autoencoder and a Bootstrap).

In some embodiments, an LSTM is utilized, e.g., for anomaly detection. LSTM is a type of recurrent neural network that may utilize a particular cell structure which allows it to control the amount of information it retains, forgets, and exposes. Thus, LSTM approaches may be well suited for machine learning of correlations in a sequential data set, e.g., for an input time series including PMs of a cloud RAN. LSTM may utilize an architecture for tracking long-term dependencies in the data, and thus may be well suited for applications relating to time series data. For example, the LSTM may be configured to forget and/or retain information, to expose certain information, etc., which may be suitable for time series data.

In some embodiments, an autoencoder may be configured for performing a reconstruction process of its own input. A reconstruction error may be used to identify anomalies in the input data.

In some embodiments, a forecaster may be configured for predicting future samples based on observed samples, and an anomaly detection process may be performed between the forecasted and the observed samples.

In some embodiments, a Bootstrap process may be configured for evaluating the properties of the train and test data and flags a failure, e.g., in case the deviation in statistical metrics falls above or below various thresholds.

In some embodiments, an autoencoder may be used for anomaly detection. In some embodiments, some features from the input may be extracted, which may expose other PMs, and those features may be used to compress and/or decompress the features If there is any reconstruction error, then the autoencoder may have been input with data it is not trained with, and which it may flag as anomalies. The autoencoder may be trained with properly functioning software, and if any anomalies in the new software (e.g., after a software version update), the anomalies may be detected which may indicate a need to roll back a software update.

In some embodiments, a forecaster may be trained with data associated with properly functioning software (e.g., of a current software version), and may use this data to forecast the PMs that should be output from the new software (e.g., a new software version after a software update), and then compares that output with expected values, e.g., for anomaly detection.

In some embodiments, a Bootstrap procedure may utilize a statistical model or algorithm in which statistic metrics associated with comparisons of the distribution between two datasets, e.g., the dataset associated with a properly functioning software which is version 1, with a dataset associated with a distribution of a new software version 2. The Bootstrap procedure may be configured to flag any differences between the statistical distributions/metrics. In some embodiments, a bootstrap procedure may not require training, e.g., it may include collecting data associated with an old software version and a new software version, and may be sensitive to the distributions of the datasets.

In some embodiments, operations/computations/analysis/training/etc. may be performed on multi-variate time series of PMs. In addition, some embodiments may provide configurations which include unsupervised learning, e.g., which may not require that there be labels in the input data identifying the anomalous points during the training phase. For example, non-anomalous PMs (and/or anomalous PMs) may be collected from a customer network (e.g., a cloud RAN) are may be used as data for training one or more AI models and/or machine learning models and/or other statistical models/techniques, as described herein.

In some embodiments, in identifying a software failure with an autoencoder and/or a forecaster, the use of point anomalies may be avoided. In RAN software, for example, segment anomalies may, in some cases, be more indicative of a software failure, whereas point anomalies might represent dynamic change in network conditions, such as channel variations which do not necessarily contribute to software failure. Therefore, in some embodiments of the present disclosure, configurations are provided for processing point anomalies produced by one or more of the various AI models described herein, e.g., for identifying segment anomalies, which may in turn be used identifying software failure.

In addition, in some embodiments of the present disclosure, methods for global model design may be provided. For example, some embodiments may provide training procedures for a variety of AI models using the data from different network nodes (e.g., gNBs). Furthermore, because the various AI models described herein may accept time series PMs in the form of windows, in some embodiments, a window size tuning approach may be utilized for finding an optimal window size.

Embodiments of the present disclosure may be configured for intelligently/autonomously identifying the health of a canary deployment in cloud RAN. For example, embodiments may advantageously reduce the cost of human intervention, e.g., in a software deployment process, and may reduce time needed for analyzing a canary deployment process, as compared to some existing solutions. Embodiments of the present disclosure may utilize one or more of an LSTM-based autoencoder, a forecaster for anomaly detection, a Bootstrap approach, and an ensemble approach.

Some current cloud RAN systems may require extensive testing during software release/deployment processes. This may require monitoring different PMs over an extended duration, e.g., by a test engineer. Embodiments of the present disclosure may enable automation of one or more elements of a software deployment process, e.g., through an AI-based canary judge process for cloud RAN. Embodiments of the present disclosure may reduce the need for human intervention and/or the time needed to identify failure in the canary deployment process, as compared to some existing systems.

According to a first aspect of the present disclosure, a management node in a wireless communication system including a plurality of network nodes is provided. The management node is configured to train a machine learning model using an historical dataset of performance metrics associated with at least one network node configured with at least one software version of a plurality of software versions, where the historical dataset of performance metrics is associated with a non-anomalous (e.g., “normal”, error free operation, operation with acceptably low error/anomaly levels, etc.) state of the at least one network node. The management node is configured to receive a first dataset of performance metrics associated with a first network node configured with a second software version of the plurality of software versions, which is an update of a first software version (e.g., a previous software version on which the machine learning model was trained, or a previous software version which is a later version of one or more previous versions on which the machine learning model was trained, etc.) of the plurality of software versions. The management node is configured to perform a first anomaly detection on the first dataset of performance metrics using the trained machine learning model to determine a number of anomalies of the first dataset of performance metrics.

According to one or more embodiments of this aspect, the management node is further configured to perform the first anomaly detection by determining a plurality of point anomalies associated with the first set of performance metrics, grouping at least a portion of the plurality of point anomalies into a plurality of corresponding segments, and determining, for the plurality of point anomalies, a corresponding plurality of weight values based on the plurality of corresponding anomaly segments, and determining the number of anomalies of the first dataset of performance metrics based on the plurality of point anomalies and the corresponding plurality of weight values.

According to one or more embodiments of this aspect, the management node is further configured to determine the corresponding plurality of weight values by assigning a first weight value to point anomalies belonging to a first corresponding segment which has fewer than a threshold number of point anomalies belonging to the first corresponding segment, and assigning a second weight value to point anomalies belonging to a second corresponding segment which has greater than the threshold number of point anomalies belonging to the second corresponding segment. According to one or more embodiments of this aspect, the first weight value is 0.

According to one or more embodiments of this aspect, the management node is configured to either (optionally) cause a rollback of the first network node from the second software version to the first software version based on the first number of anomalies being greater than a first preconfigured threshold, or to (optionally) cause migration of at least one additional network node from the first software version to the second software version based on the first number of anomalies being below the first preconfigured threshold.

According to one or more embodiments of this aspect, the management node is further configured to, responsive to causing migration of the at least one additional network node to the second software version, receive an additional dataset of performance metrics associated with the at least one additional network node, perform a second anomaly detection on the additional dataset of performance metrics using the machine learning model, and to either (optionally) cause migration of a remainder of the plurality of network nodes from the first software version to the second software version responsive to the second anomaly detection detecting a second number of anomalies below a second preconfigured anomaly threshold, or to (optionally) cause a rollback of the at least one additional network node and the first network node from the second software version to the first software version based on the second number of anomalies being above the second preconfigured anomaly threshold.

According to one or more embodiments of this aspect, the first software version and second software version correspond to versions of baseband software.

According to one or more embodiments of this aspect, the management node is further configured to train the machine learning model by determining a plurality of performance metric types of the historical dataset of performance metrics, determining at least one statistical correlation between at least one pair of the plurality of performance metric types based on the historical dataset of performance metrics, determining a subset of the plurality of performance metric types based on the at least one statistical correlation exceeding a preconfigured correlation threshold, and training the machine learning model using the subset of the plurality of performance metric types as a plurality of features.

According to one or more embodiments of this aspect, the management node is further configured to perform the first anomaly detection on the first set of performance metrics using the trained machine learning model based on the subset of the plurality of performance metric types from the first dataset of performance metrics.

According to one or more embodiments of this aspect, the machine learning model includes a Long Short-term Memory (LSTM) autoencoder, and the management node is further configured to perform the first anomaly detection by encoding the first dataset of performance metrics using the LSTM autoencoder, decoding the first dataset of performance metrics using the LSTM autoencoder to determine a reconstruction error metric, and detecting at least one anomaly associated with the first dataset based on the reconstruction error metric exceeding a preconfigured threshold.

According to one or more embodiments of this aspect, the management node is further configured to perform the first anomaly detection by determining a predicted dataset of performance metrics using the machine learning model based on the historical dataset of performance metrics, and detecting the first number of anomalies of the first dataset of performance metrics based on the first dataset of performance metrics deviating from the predicted dataset of performance metrics by at least a preconfigured threshold.

According to one or more embodiments of this aspect, the management node is further configured to perform the first anomaly detection by determining an historical set of statistical metrics associated with the historical dataset, determining a first set of statistical metrics associated with the first dataset, and determining the number of anomalies based on the first set of statistical metrics deviating from the historical set of statistical metrics by at least a preconfigured threshold amount.

According to one or more embodiments of this aspect, the management node is further configured to perform a second anomaly detection on the first dataset (e.g., using a different machine learning model than used for the first anomaly detection). The management node is further configured to determine a weighted sum of at least one first error metric of the first anomaly detection, and at least one second error metric second anomaly detection. The management node is further configured to (optionally) cause a rollback of the first network node from the second software version to the first software version based on the weighted sum being greater than a first preconfigured threshold. This may correspond, in some embodiments, to an “ensemble” method, as described herein.

According to another aspect of the present disclosure, a method implemented in a management node in a wireless communication system including a plurality of network nodes is provided. The method includes training a machine learning model using an historical dataset of performance metrics associated with at least one network node configured with at least one software version of a plurality of software versions, where the historical dataset of performance metrics is associated with a non-anomalous state of the at least one network node. The method includes receiving a first dataset of performance metrics associated with a first network node configured with a second software version of the plurality of software versions, which is an update of a first software version of the plurality of software versions. The method includes performing a first anomaly detection on the first dataset of performance metrics using the trained machine learning model to determine a number of anomalies of the first dataset of performance metrics.

According to one or more embodiments of this aspect, the method further includes performing the first anomaly detection by determining a plurality of point anomalies associated with the first set of performance metrics, grouping at least a portion of the plurality of point anomalies into a plurality of corresponding segments, and determining, for the plurality of point anomalies, a corresponding plurality of weight values based on the plurality of corresponding anomaly segments, and determining the number of anomalies of the first dataset of performance metrics based on the plurality of point anomalies and the corresponding plurality of weight values.

According to one or more embodiments of this aspect, the method further includes determining the corresponding plurality of weight values by assigning a first weight value to point anomalies belonging to a first corresponding segment which has fewer than a threshold number of point anomalies belonging to the first corresponding segment, and assigning a second weight value to point anomalies belonging to a second corresponding segment which has greater than the threshold number of point anomalies belonging to the second corresponding segment. According to one or more embodiments of this aspect, the first weight value is 0.

According to one or more embodiments of this aspect, the method includes either (optionally) causing a rollback of the first network node from the second software version to the first software version based on the first number of anomalies being greater than a first preconfigured threshold, or (optionally) causing migration of at least one additional network node from the first software version to the second software version based on the first number of anomalies being below the first preconfigured threshold.

According to one or more embodiments of this aspect, the method further includes, responsive to causing migration of the at least one additional network node to the second software version, receiving an additional dataset of performance metrics associated with the at least one additional network node, performing a second anomaly detection on the additional dataset of performance metrics using the machine learning model, and either (optionally) causing migration of a remainder of the plurality of network nodes from the first software version to the second software version responsive to the second anomaly detection detecting a second number of anomalies below a second preconfigured anomaly threshold, or (optionally) causing a rollback of the at least one additional network node and the first network node from the second software version to the first software version based on the second number of anomalies being above the second preconfigured anomaly threshold.

According to one or more embodiments of this aspect, the first software version and second software version correspond to versions of baseband software.

According to one or more embodiments of this aspect, the method further includes training the machine learning model by determining a plurality of performance metric types of the historical dataset of performance metrics, determining at least one statistical correlation between at least one pair of the plurality of performance metric types based on the historical dataset of performance metrics, determining a subset of the plurality of performance metric types based on the at least one statistical correlation exceeding a preconfigured correlation threshold, and training the machine learning model using the subset of the plurality of performance metric types as a plurality of features.

According to one or more embodiments of this aspect, the method further includes performing the first anomaly detection on the first set of performance metrics using the trained machine learning model based on the subset of the plurality of performance metric types from the first dataset of performance metrics.

According to one or more embodiments of this aspect, the machine learning model includes a Long Short-term Memory (LSTM) autoencoder, and the method further includes performing the first anomaly detection by encoding the first dataset of performance metrics using the LSTM autoencoder, decoding the first dataset of performance metrics using the LSTM autoencoder to determine a reconstruction error metric, and detecting at least one anomaly associated with the first dataset based on the reconstruction error metric exceeding a preconfigured threshold.

According to one or more embodiments of this aspect, the method further includes performing the first anomaly detection by determining a predicted dataset of performance metrics using the machine learning model based on the historical dataset of performance metrics, and detecting the first number of anomalies of the first dataset of performance metrics based on the first dataset of performance metrics deviating from the predicted dataset of performance metrics by at least a preconfigured threshold.

According to one or more embodiments of this aspect, the method further includes performing the first anomaly detection by determining an historical set of statistical metrics associated with the historical dataset, determining a first set of statistical metrics associated with the first dataset, and determining the number of anomalies based on the first set of statistical metrics deviating from the historical set of statistical metrics by at least a preconfigured threshold amount.

According to one or more embodiments of this aspect, the method further includes performing a second anomaly detection on the first dataset (e.g., using a different machine learning model than used for the first anomaly detection). The method further includes determining a weighted sum of at least one first error metric of the first anomaly detection, and at least one second error metric second anomaly detection. The method further includes (optionally) causing a rollback of the first network node from the second software version to the first software version based on the weighted sum being greater than a first preconfigured threshold. This may correspond, in some embodiments, to an “ensemble” method, as described herein.

According to another aspect of the present disclosure, a wireless communication system including a management node and a plurality of network nodes is provided. At least one network node is configured to determine at least one performance metric associated with the at least one network node. The network node is configured to cause transmission of an indication of the at least one performance metric to a management node. The management node is configured to train a machine learning model using a historical dataset of performance metrics associated with at least one network node configured with at least one software version of a plurality of software versions, where the historical dataset of performance metrics are associated with a non-anomalous state of the at least one network node. The management node is configured to receive a first dataset of performance metrics associated with a first network node configured with a second software version of the plurality of software versions which is an update of a first software version of the plurality of software versions. The management node is configured to perform a first anomaly detection on the first dataset of performance metrics using the trained machine learning model to determine a number of anomalies of the first dataset of performance metrics.

According to one or more embodiments of this aspect, the management node is further configured to perform the first anomaly detection by determining a plurality of point anomalies associated with the first set of performance metrics, grouping at least a portion of the plurality of point anomalies into a plurality of corresponding segments, determining, for the plurality of point anomalies, a corresponding plurality of weight values based on the plurality of corresponding anomaly segments, and determining the number of anomalies of the first dataset of performance metrics based on the plurality of point anomalies and the corresponding plurality of weight values.

According to one or more embodiments of this aspect, the management node is further configured to determine the corresponding plurality of weight values by assigning a first weight value to point anomalies belonging to a first corresponding segment which has fewer than a threshold number of point anomalies belonging to the first corresponding segment, and assigning a second weight value to point anomalies belonging to a second corresponding segment which has greater than the threshold number of point anomalies belonging to the second corresponding segment. According to one or more embodiments of this aspect, the first weight value is 0.

According to one or more embodiments of this aspect, the management node is further configured to either (optionally) cause a rollback of the first network node from the second software version to the first software version based on the first number of anomalies being greater than a first preconfigured threshold, or to (optionally) cause migration of at least one additional network node from the first software version to the second software version based on the first number of anomalies being below the first preconfigured threshold.

According to one or more embodiments of this aspect, the management node is further configured to, responsive to causing migration of the at least one additional network node to the second software version, receive an additional dataset of performance metrics associated with the at least one additional network node, to perform a second anomaly detection on the additional dataset of performance metrics using the machine learning model, and to either (optionally) cause migration of a remainder of the plurality of network nodes from the first software version to the second software version responsive to the second anomaly detection detecting a second number of anomalies below a second preconfigured anomaly threshold, or to (optionally) cause a rollback of the at least one additional network node and the first network node from the second software version to the first software version based on the second number of anomalies being above the second preconfigured anomaly threshold.

According to one or more embodiments of this aspect, the first software version and second software version correspond to versions of baseband software.

According to one or more embodiments of this aspect, the management node is further configured to train the machine learning model by determining a plurality of performance metric types of the historical dataset of performance metrics, determining at least one statistical correlation between at least one pair of the plurality of performance metric types based on the historical dataset of performance metrics, determining a subset of the plurality of performance metric types based on the at least one statistical correlation exceeding a preconfigured correlation threshold, and training the machine learning model using the subset of the plurality of performance metric types as a plurality of features.

According to one or more embodiments of this aspect, the management node is further configured to perform the first anomaly detection on the first set of performance metrics using the trained machine learning model based on the subset of the plurality of performance metric types from the first dataset of performance metrics.

According to one or more embodiments of this aspect, the machine learning model includes a Long Short-term Memory (LSTM) autoencoder, and the management node is further configured to perform the first anomaly detection by encoding the first dataset of performance metrics using the LSTM autoencoder, decoding the first dataset of performance metrics using the LSTM autoencoder to determine a reconstruction error metric, and detecting at least one anomaly associated with the first dataset based on the reconstruction error metric exceeding a preconfigured threshold.

According to one or more embodiments of this aspect, the management node is further configured to perform the first anomaly detection by determining a predicted dataset of performance metrics using the machine learning model based on the historical dataset of performance metrics, and detecting the first number of anomalies of the first dataset of performance metrics based on the first dataset of performance metrics deviating from the predicted dataset of performance metrics by at least a preconfigured threshold.

According to one or more embodiments of this aspect, the management node is further configured to perform the first anomaly detection by determining an historical set of statistical metrics associated with the historical dataset, determining a first set of statistical metrics associated with the first dataset, and determining the number of anomalies based on the first set of statistical metrics deviating from the historical set of statistical metrics by at least a preconfigured threshold amount.

According to one or more embodiments of this aspect, the management node is further configured to perform a second anomaly detection on the first dataset (e.g., using a different machine learning model than used for the first anomaly detection). The management node is further configured to determine a weighted sum of at least one first error metric of the first anomaly detection, and at least one second error metric second anomaly detection. The management node is further configured to (optionally) cause a rollback of the first network node from the second software version to the first software version based on the weighted sum being greater than a first preconfigured threshold. This may correspond, in some embodiments, to an “ensemble” method, as described herein.

According to another aspect of the present disclosure, a method implemented in a wireless communication system including a management node and a plurality of network nodes is provided. The method includes determining at least one performance metric associated with the at least one network node, and causing transmission of an indication (e.g., from a network node) of the at least one performance metric to a management node. The method further includes training a machine learning model using a historical dataset of performance metrics associated with at least one network node configured with at least one software version of a plurality of software versions, where the historical dataset of performance metrics are associated with a non-anomalous state of the at least one network node. The method includes, at the management node, receiving a first dataset of performance metrics associated with a first network node configured with a second software version of the plurality of software versions which is an update of a first software version of the plurality of software versions. The method includes performing a first anomaly detection on the first dataset of performance metrics using the trained machine learning model to determine a number of anomalies of the first dataset of performance metrics.

According to one or more embodiments of this aspect, the method further includes performing the first anomaly detection by determining a plurality of point anomalies associated with the first set of performance metrics, grouping at least a portion of the plurality of point anomalies into a plurality of corresponding segments, determining, for the plurality of point anomalies, a corresponding plurality of weight values based on the plurality of corresponding anomaly segments, and determining the number of anomalies of the first dataset of performance metrics based on the plurality of point anomalies and the corresponding plurality of weight values.

According to one or more embodiments of this aspect, the method further includes determining the corresponding plurality of weight values by assigning a first weight value to point anomalies belonging to a first corresponding segment which has fewer than a threshold number of point anomalies belonging to the first corresponding segment, and assigning a second weight value to point anomalies belonging to a second corresponding segment which has greater than the threshold number of point anomalies belonging to the second corresponding segment. According to one or more embodiments of this aspect, the first weight value is 0.

According to one or more embodiments of this aspect, the method further includes either (optionally) causing a rollback of the first network node from the second software version to the first software version based on the first number of anomalies being greater than a first preconfigured threshold, or (optionally) causing migration of at least one additional network node from the first software version to the second software version based on the first number of anomalies being below the first preconfigured threshold.

According to one or more embodiments of this aspect, the method further includes, responsive to causing migration of the at least one additional network node to the second software version, receiving an additional dataset of performance metrics associated with the at least one additional network node, performing a second anomaly detection on the additional dataset of performance metrics using the machine learning model, and either (optionally) causing migration of a remainder of the plurality of network nodes from the first software version to the second software version responsive to the second anomaly detection detecting a second number of anomalies below a second preconfigured anomaly threshold, or (optionally) causing a rollback of the at least one additional network node and the first network node from the second software version to the first software version based on the second number of anomalies being above the second preconfigured anomaly threshold.

According to one or more embodiments of this aspect, the first software version and second software version correspond to versions of baseband software.

According to one or more embodiments of this aspect, the method further includes training the machine learning model by determining a plurality of performance metric types of the historical dataset of performance metrics, determining at least one statistical correlation between at least one pair of the plurality of performance metric types based on the historical dataset of performance metrics, determining a subset of the plurality of performance metric types based on the at least one statistical correlation exceeding a preconfigured correlation threshold, and training the machine learning model using the subset of the plurality of performance metric types as a plurality of features.

According to one or more embodiments of this aspect, the method further includes performing the first anomaly detection on the first set of performance metrics using the trained machine learning model based on the subset of the plurality of performance metric types from the first dataset of performance metrics.

According to one or more embodiments of this aspect, the machine learning model includes a Long Short-term Memory (LSTM) autoencoder, and the method further includes performing the first anomaly detection by encoding the first dataset of performance metrics using the LSTM autoencoder, decoding the first dataset of performance metrics using the LSTM autoencoder to determine a reconstruction error metric, and detecting at least one anomaly associated with the first dataset based on the reconstruction error metric exceeding a preconfigured threshold.

According to one or more embodiments of this aspect, the method further includes performing the first anomaly detection by determining a predicted dataset of performance metrics using the machine learning model based on the historical dataset of performance metrics, and detecting the first number of anomalies of the first dataset of performance metrics based on the first dataset of performance metrics deviating from the predicted dataset of performance metrics by at least a preconfigured threshold. According to one or more embodiments of this aspect, the method further includes performing the first anomaly detection by determining an historical set of statistical metrics associated with the historical dataset, determining a first set of statistical metrics associated with the first dataset, and determining the number of anomalies based on the first set of statistical metrics deviating from the historical set of statistical metrics by at least a preconfigured threshold amount.

According to one or more embodiments of this aspect, the method further includes performing a second anomaly detection on the first dataset (e.g., using a different machine learning model than used for the first anomaly detection). The method further includes determining a weighted sum of at least one first error metric of the first anomaly detection, and at least one second error metric second anomaly detection. The method further includes (optionally) causing a rollback of the first network node from the second software version to the first software version based on the weighted sum being greater than a first preconfigured threshold. This may correspond, in some embodiments, to an “ensemble” method, as described herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a management node for supporting an AI-based canary judge process for a canary deployment process in a RAN, such as a cloud RAN according to some embodiments of the present disclosure;

FIG. 8 is a flowchart of an example process in a wireless communication network including a management node and one or more network nodes for supporting an AI-based canary judge process for a canary deployment process in a RAN, such as a cloud RAN according to some embodiments of the present disclosure;

FIG. 9 is a timing diagram illustrating an example configuration according to some embodiments of the present disclosure;

FIG. 10 is a diagram illustrating an example architecture and process flow for an AI-based canary judge process for both training and inference, according to some embodiments of the present disclosure;

FIG. 11 is a timing diagram which illustrates an example time series, according to some embodiments of the present disclosure;

FIG. 12 is a diagram illustrating an example architecture and process flow for an autoencoder including a verdict generation process, according to some embodiments of the present disclosure;

FIG. 13 is a diagram which illustrates an example process flow for identifying anomalous segments, according to some embodiments of the present disclosure;

FIG. 14 is a diagram which illustrates an example process flow for a verdict calculation process, according to some embodiments of the present disclosure;

FIG. 15 is a diagram which illustrates two example training methods according to some embodiments of the present disclosure;

FIG. 16 is a diagram which illustrates an architecture and process flow of a forecaster, e.g., an LSTM forecaster, according to some embodiments of the present disclosure;

FIG. 17 is a diagram which illustrates an example architecture and process flow for a Bootstrap method according to some embodiments of the present disclosure; and

FIG. 18 is a flowchart which illustrates an example ensemble technique for an autoencoder process and a bootstrap process, according to some embodiments of the present disclosure.

### DETAILED DESCRIPTION

Before describing in detail example embodiments, it is noted that the embodiments reside primarily in combinations of apparatus components and processing steps related to configurations for supporting an AI-based canary judge process for a canary deployment process in a RAN, such as a cloud RAN. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the term “management node” may be used. A management node may be any kind of node, such as a network node, core node, cloud node, virtual node, host computer, server, etc., and may be implemented in a variety of different devices and/or networks, such as an access network, a core network, a cloud RAN, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting an AI-based canary judge process for a canary deployment process in a RAN, such as a cloud RAN.

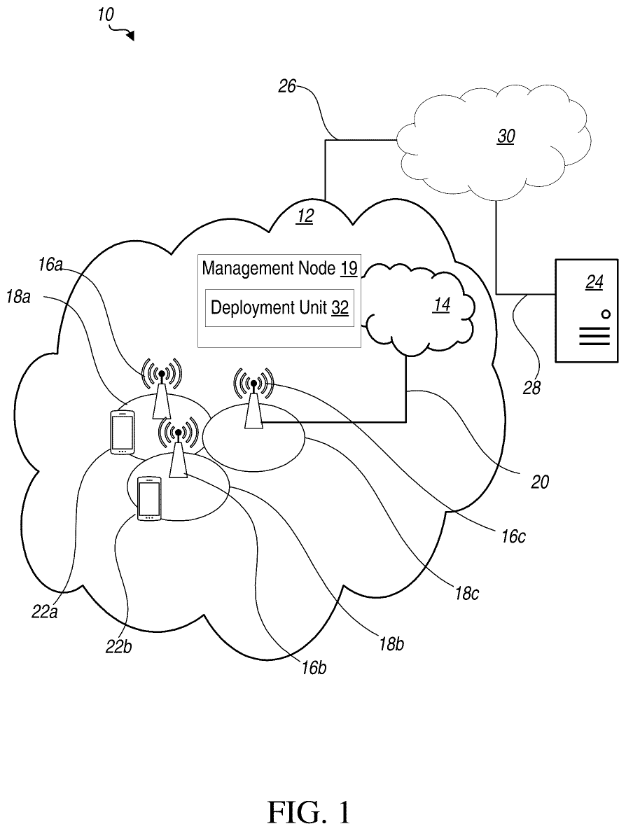

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding cells (i.e., coverage area) 18a, 18b, 18c (referred to collectively as cells 18). The access network 12 and/or core network 14 and/or system 10 may include a management node 19, which is configured for managing, configuring, orchestrating, measuring, etc., one or more configurations for a network, such as for deploying software versions in a cloud RAN. The management node 19 may be configured to communicate with one or more network nodes 16 (e.g., to send or receive configuration information, software packages, etc.), and/or may receive metrics (e.g., PMs, measurement data, configuration data, etc.) associated with one or more network nodes 16. Each network node 16a, 16b, 16c is connectable to the core network 14 over a wired or wireless connection 20. A first wireless device (WD) 22a located in cell (coverage area) 18a is configured to wirelessly connect to, or be paged by, the corresponding network node 16a. A second WD 22b in cell (coverage area) 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the cell (coverage area) or where a sole WD is connecting to the corresponding network node 16. Note that although only two WDs 22, three network nodes 16, and one management node 19 are shown for convenience, the communication system may include many more WDs 22, network nodes 16, and management nodes 19.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown). In some embodiments, a host computer 24 may include and/or may perform one or more functions of a management node 19, as described herein.

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A management node 19 is configured to include a deployment unit 32 which is configured for supporting an AI-based canary judge process for a canary deployment process in a RAN, such as a cloud RAN.

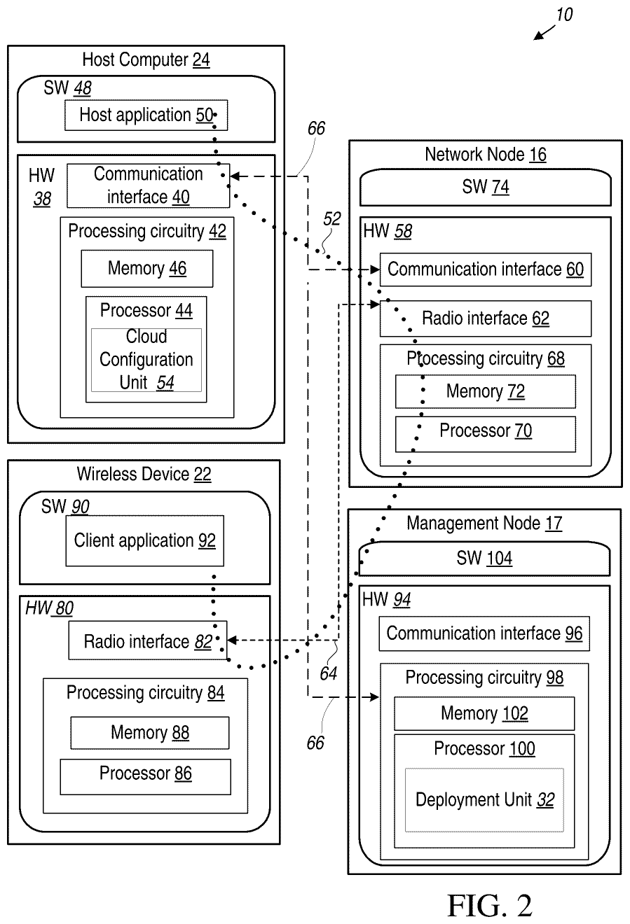

Example implementations, in accordance with an embodiment, of the WD 22, network node 16, management node 19, and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16, management node 19, and/or the wireless device 22. The processing circuitry 42 of the host computer 24 may include a Cloud Configuration unit 54 configured to enable the service provider to observe/monitor/control/transmit to/receive from/configure/etc. the network node 16, management node 19, and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a cell (coverage area) 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a cell (coverage area) 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

The communication system 10 further includes a management node 19 provided in a communication system 10 and including hardware 94 enabling it to communicate with the host computer 24, with other management nodes 19, with one or more network nodes 16, with one or more WDs 22, etc. The hardware 94 may include a communication interface 96 for setting up and maintaining a wired or wireless connection with an interface of a different communication device of the communication system 10. The communication interface 96 may be configured to facilitate a connection 66 to the host computer 24 and/or one or more network nodes 16 and/or WDs 22 and/or other management nodes 19, core nodes, etc. The connection 66 may be direct or it may pass through a core network 14 of the communication system 10 and/or through one or more intermediate networks 30 outside the communication system 10.

In the embodiment shown, the hardware 94 of the management node 19 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the management node 19 further has software 104 stored internally in, for example, memory 102, or stored in external memory (e.g., database, storage array, network storage device, etc.) accessible by the management node 19 via an external connection. The software 104 may be executable by the processing circuitry 98. The processing circuitry 98 may be configured to control any of the methods and/or processes described herein and/or to cause such methods, and/or processes to be performed, e.g., by management node 19. Processor 100 corresponds to one or more processors 100 for performing management node 19 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to management node 19. For example, processing circuitry 98 of the management node 19 may include deployment unit 32 which is configured for supporting an AI-based canary judge process for a canary deployment process in a RAN, such as a cloud RAN.

In some embodiments, the inner workings of the network node 16, management node 19, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24, the management node 19, and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as deployment unit 32, as being within a respective processor, it is contemplated that these units may be implemented such that a portion of the unit is stored in a corresponding memory within the processing circuitry. In other words, the units may be implemented in hardware or in a combination of hardware and software within the processing circuitry.

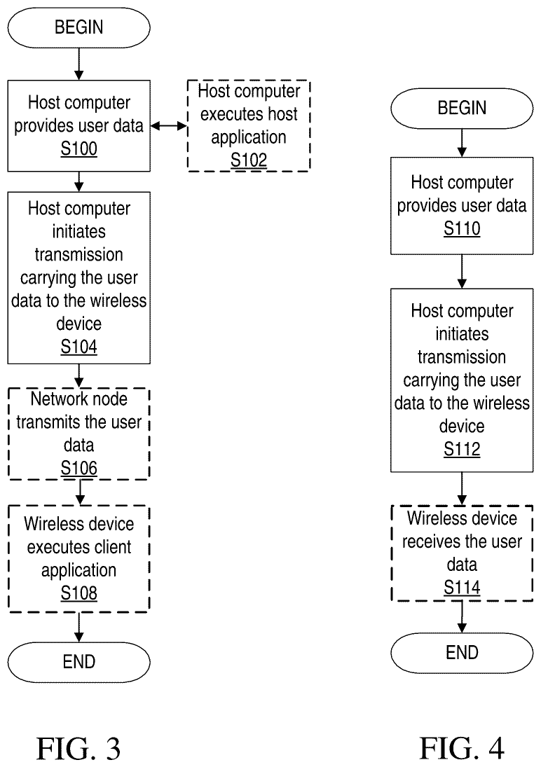

FIG. 3 is a flowchart illustrating an example method implemented in a communication system, such as, for example, the communication system of FIGS. 1 and 2, in accordance with one embodiment. The communication system may include a host computer 24, a network node 16, a management node 19, and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

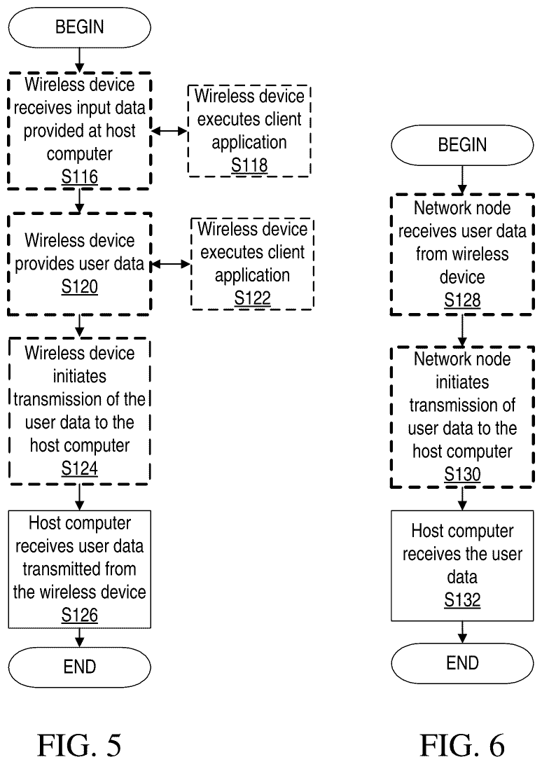

FIG. 5 is a flowchart illustrating an example method implemented in a communication system, such as, for example, the communication system of FIG. 1, in accordance with one embodiment. The communication system may include a host computer 24, a network node 16, a management node 19, and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16, a management node 19, and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

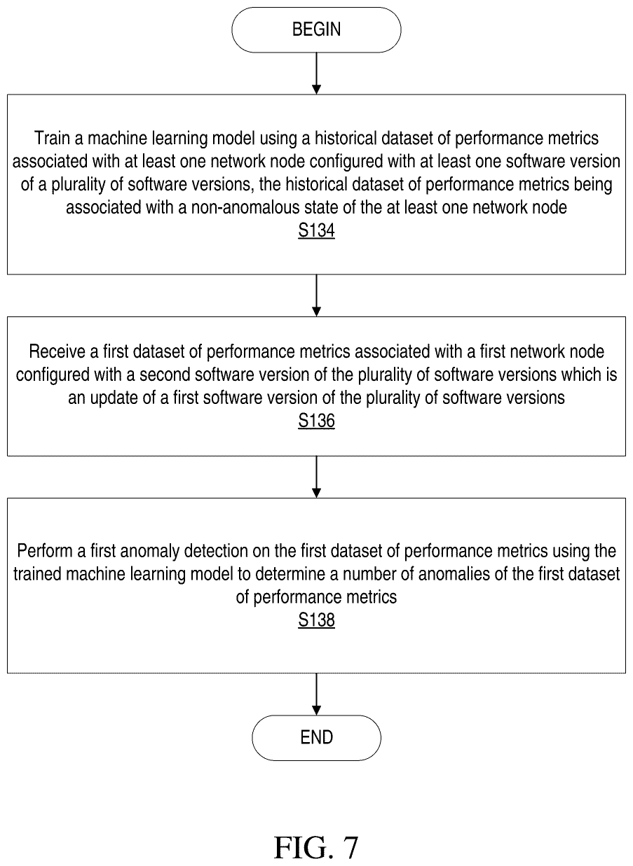

FIG. 7 is a flowchart of an example process in a management node 19 according to some embodiments of the present disclosure. One or more blocks described herein may be performed by one or more elements of management node 19 such as by one or more of processing circuitry 98 (including the deployment unit 32), processor 100, and/or communication interface 96. Management node 19 is configured to train (Block S134) a machine learning model using an historical dataset of performance metrics (e.g., one or more KPIs, PM counters, PM events, trace logs, etc.) associated with at least one network node 16 configured with at least one software version (e.g., referred to as a “first software version” and/or a “previous software version” and/or a “current software version”) of a plurality of software versions, where the historical dataset of performance metrics is associated with a non-anomalous (e.g., “normal”, error free, acceptably low error/anomaly levels, etc.) state of the at least one network node 16.

Management node 19 is configured to receive (Block S136) a first dataset of performance metrics associated with a first network node 16 configured with a second software version of the plurality of software versions, which is an update of a first (and/or previous and/or current) software version of the plurality of software versions.

For example, in some embodiments, the machine learning model may have been trained with one or more earlier versions (e.g., Versions 1, 2, and 3) of the plurality of software versions, where the “first version” corresponds to a later and/or current version (e.g., Version 4), or some other version (e.g., Version 2.5) of the plurality of software versions, and thus, the “first version” may, in some embodiments, not have been used to train the machine learning model, depending on the configuration, timing, implementation details, etc. In some embodiments, the “first version” may correspond to the one or more versions on which the machine learning model was trained (e.g., the machine learning model was trained on Versions 1, 2, 3, and 4, where the “first version” corresponds to Version 4). In some embodiments, the machine learning model is only trained on the “first version” (e.g., the “current version”, which is Version 4 in this example), which may include disregarding data associated with earlier software versions (e.g., Versions 1-3 in this example) when training or retraining the machine learning model. In some embodiments, data associated with earlier versions of the model may be weighted less in the training of the model as compared to later/current version(s). The machine learning model may have also been trained on the “second version” (e.g., Version 5 in this example, i.e., a version subsequent to the “first version”, Version 4), for example, if data associated with Version 5 is available. In some embodiments, the machine learning model may not have been trained on the second version (e.g., Version 5 in this example), may only be trained on the previous and/or current version(s) of the plurality of software versions.

Referring still to FIG. 7, management node 19 is configured to perform (Block S138) a first anomaly detection on the first dataset of performance metrics using the trained machine learning model to determine a number of anomalies of the first dataset of performance metrics.

In some embodiments, management node 19 is further configured to perform the first anomaly detection by determining a plurality of point anomalies associated with the first set of performance metrics, grouping at least a portion of the plurality of point anomalies into a plurality of corresponding segments, and determining, for the plurality of point anomalies, a corresponding plurality of weight values based on the plurality of corresponding anomaly segments, and determining the number of anomalies of the first dataset of performance metrics based on the plurality of point anomalies and the corresponding plurality of weight values.

In some embodiments, the management node 19 is further configured to determine the corresponding plurality of weight values by assigning a first weight value to point anomalies belonging to a first corresponding segment which has fewer than a threshold number of point anomalies belonging to the first corresponding segment, and assigning a second weight value to point anomalies belonging to a second corresponding segment which has greater than the threshold number of point anomalies belonging to the second corresponding segment. In some embodiments, the first weight value is 0.

In some embodiments, the management node 19 is configured to either (optionally, e.g., based on configuration information, user input, etc.) cause a rollback of the first network node 16 from the second software version to the first software version based on the first number of anomalies being greater than a first preconfigured threshold, or to (optionally) cause migration of at least one additional network node 16 from the first software version to the second software version based on the first number of anomalies being below the first preconfigured threshold. In some embodiments, in causing a migration (or rollback) of an at least one additional network node 16, the at least one additional network node 16 may be include any entity of system 10, for example, one or more network nodes 16 of the same cell 18 and/or an additional cell 18, a managed object, such as a cloud native function (CNF) of at least one network node 16, a wireless device 22, etc.

In some embodiments, the management node 19 is further configured to, responsive to causing migration of the at least one additional network node 16 to the second software version, receive an additional dataset of performance metrics associated with the at least one additional network node 16, perform a second anomaly detection on the additional dataset of performance metrics using the machine learning model, and to either (optionally) cause migration of a remainder of the plurality of network nodes 16 from the first software version to the second software version responsive to the second anomaly detection detecting a second number of anomalies below a second preconfigured anomaly threshold, or to (optionally) cause a rollback of the at least one additional network node 16 and the first network node 16 from the second software version to the first software version based on the second number of anomalies being above the second preconfigured anomaly threshold.

In some embodiments, the first software version and second software version correspond to versions of baseband software.

In some embodiments, the management node 19 is further configured to train the machine learning model by determining a plurality of performance metric types of the historical dataset of performance metrics, determining at least one statistical correlation between at least one pair of the plurality of performance metric types based on the historical dataset of performance metrics, determining a subset of the plurality of performance metric types based on the at least one statistical correlation exceeding a preconfigured correlation threshold, and training the machine learning model using the subset of the plurality of performance metric types as a plurality of features.

In some embodiments, the management node 19 is further configured to perform the first anomaly detection on the first set of performance metrics using the trained machine learning model based on the subset of the plurality of performance metric types from the first dataset of performance metrics.

In some embodiments, the machine learning model includes a Long Short-term Memory (LSTM) autoencoder, and the management node 19 is further configured to perform the first anomaly detection by encoding the first dataset of performance metrics using the LSTM autoencoder, decoding the first dataset of performance metrics using the LSTM autoencoder to determine a reconstruction error metric, and detecting at least one anomaly associated with the first dataset based on the reconstruction error metric exceeding a preconfigured threshold.

In some embodiments, the management node 19 is further configured to perform the first anomaly detection by determining a predicted dataset of performance metrics using the machine learning model based on the historical dataset of performance metrics, and detecting the first number of anomalies of the first dataset of performance metrics based on the first dataset of performance metrics deviating from the predicted dataset of performance metrics by at least a preconfigured threshold.

In some embodiments, management node 19 is further configured to perform the first anomaly detection by determining an historical set of statistical metrics associated with the historical dataset, determining a first set of statistical metrics associated with the first dataset, and determining the number of anomalies based on the first set of statistical metrics deviating from the historical set of statistical metrics by at least a preconfigured threshold amount. This may correspond, in some embodiments, to a “bootstrap” method, as described herein.

In some embodiments, management node 19 is further configured to perform a second anomaly detection on the first dataset (e.g., using a different machine learning model than used for the first anomaly detection). The management node 19 is further configured to determine a weighted sum of at least one first error metric of the first anomaly detection, and at least one second error metric second anomaly detection. The management node 19 is further configured to (optionally) cause a rollback of the first network node 16 from the second software version to the first software version based on the weighted sum being greater than a first preconfigured threshold. This may correspond, in some embodiments, to an “ensemble” method, as described herein.

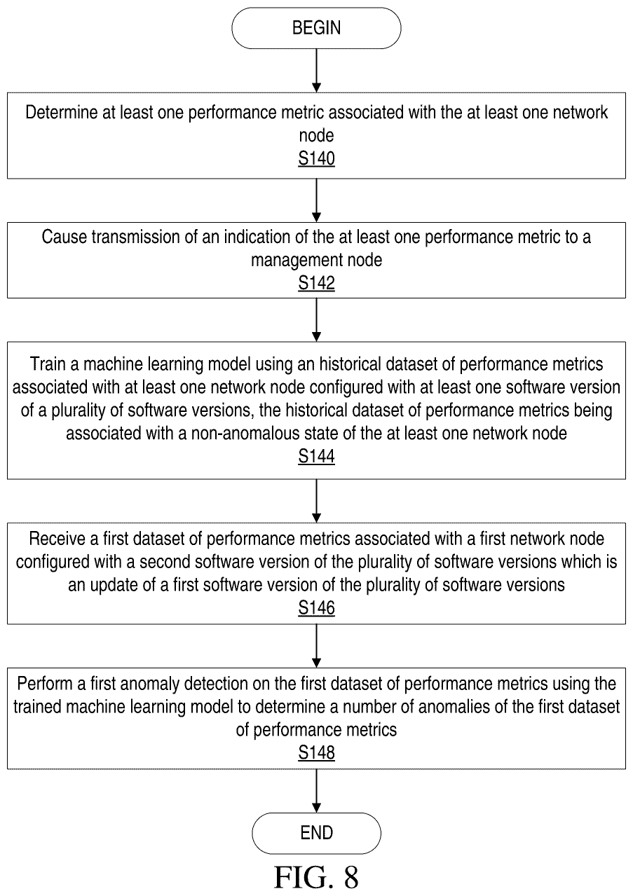

FIG. 8 is a flowchart of an example process in a wireless communication system 10 including a management node 19 and a plurality of network nodes 16, according to some embodiments of the present disclosure. One or more blocks described herein may be performed by one or more elements of management node 19 such as by one or more of processing circuitry 98 (including the deployment unit 32), processor 100, communication interface 96, and by one or more elements of network node 16, such as by one or more of processing circuitry 68, processor 70, communication interface 60, and/or radio interface 62. The network node 16 is configured to determine (Block S140) at least one performance metric (e.g., one or more KPIs, PM counters, PM events, trace logs, etc.) associated with the at least one network node 16. The network node 16 is configured to cause transmission (Block S142) of an indication of the at least one performance metric to a management node. The management node 19 is configured to train (Block S144) a machine learning model using a historical dataset of performance metrics associated with at least one network node 16 configured with at least one software version (e.g., a first and/or previous and/or current software version) of a plurality of software versions, where the historical dataset of performance metrics are associated with a non-anomalous state of the at least one network node 16. The management node 19 is configured to receive (Block S146) a first dataset of performance metrics associated with a first network node 16 configured with a second software version of the plurality of software versions which is an update of a first (and/or previous and/or current) software version of the plurality of software versions. As described above with respect to FIG. 7, the machine learning model may have been trained on data associated with one or more previous and/or current software versions of the plurality of software versions, which may or may not include the first software version. The management node 19 is configured to perform (Block S148) a first anomaly detection on the first dataset of performance metrics using the trained machine learning model to determine a number of anomalies of the first dataset of performance metrics.

In some embodiments, the management node 19 is further configured to perform the first anomaly detection by determining a plurality of point anomalies associated with the first set of performance metrics, grouping at least a portion of the plurality of point anomalies into a plurality of corresponding segments, determining, for the plurality of point anomalies, a corresponding plurality of weight values based on the plurality of corresponding anomaly segments, and determining the number of anomalies of the first dataset of performance metrics based on the plurality of point anomalies and the corresponding plurality of weight values.

In some embodiments, the management node 19 is further configured to determine the corresponding plurality of weight values by assigning a first weight value to point anomalies belonging to a first corresponding segment which has fewer than a threshold number of point anomalies belonging to the first corresponding segment, and assigning a second weight value to point anomalies belonging to a second corresponding segment which has greater than the threshold number of point anomalies belonging to the second corresponding segment. In some embodiments, the first weight value is 0.

In some embodiments, the management node 19 is further configured to either (optionally, e.g., based on configuration information, user input, etc.) cause a rollback of the first network node 16 from the second software version to the first software version based on the first number of anomalies being greater than a first preconfigured threshold, or to (optionally) cause migration of at least one additional network node 16 from the first software version to the second software version based on the first number of anomalies being below the first preconfigured threshold.

In some embodiments, the management node 19 is further configured to, responsive to causing migration of the at least one additional network node 16 to the second software version, receive an additional dataset of performance metrics associated with the at least one additional network node 16, to perform a second anomaly detection on the additional dataset of performance metrics using the machine learning model, and to either (optionally) cause migration of a remainder of the plurality of network nodes 16 from the first software version to the second software version responsive to the second anomaly detection detecting a second number of anomalies below a second preconfigured anomaly threshold, or to (optionally) cause a rollback of the at least one additional network node 16 and the first network node 16 from the second software version to the first software version based on the second number of anomalies being above the second preconfigured anomaly threshold. In some embodiments, in causing a migration (or rollback) of an at least one additional network node 16, the at least one additional network node 16 may be include any entity of system 10, for example, one or more network nodes 16 of the same cell 18 and/or an additional cell 18, a managed object, such as a cloud native function (CNF) of at least one network node 16, a wireless device 22, etc.

In some embodiments, the first software version and second software version correspond to versions of baseband software.

In some embodiments, the management node 19 is further configured to train the machine learning model by determining a plurality of performance metric types of the historical dataset of performance metrics, determining at least one statistical correlation between at least one pair of the plurality of performance metric types based on the historical dataset of performance metrics, determining a subset of the plurality of performance metric types based on the at least one statistical correlation exceeding a preconfigured correlation threshold, and training the machine learning model using the subset of the plurality of performance metric types as a plurality of features.

In some embodiments, the management node 19 is further configured to perform the first anomaly detection on the first set of performance metrics using the trained machine learning model based on the subset of the plurality of performance metric types from the first dataset of performance metrics.

In some embodiments, the machine learning model includes a Long Short-term Memory (LSTM) autoencoder, and the management node 19 is further configured to perform the first anomaly detection by encoding the first dataset of performance metrics using the LSTM autoencoder, decoding the first dataset of performance metrics using the LSTM autoencoder to determine a reconstruction error metric, and detecting at least one anomaly associated with the first dataset based on the reconstruction error metric exceeding a preconfigured threshold.

In some embodiments, the management node 19 is further configured to perform the first anomaly detection by determining a predicted dataset of performance metrics using the machine learning model based on the historical dataset of performance metrics, and detecting the first number of anomalies of the first dataset of performance metrics based on the first dataset of performance metrics deviating from the predicted dataset of performance metrics by at least a preconfigured threshold.

In some embodiments, the management node 19 is further configured to perform the first anomaly detection by determining an historical set of statistical metrics associated with the historical dataset, determining a first set of statistical metrics associated with the first dataset, and determining the number of anomalies based on the first set of statistical metrics deviating from the historical set of statistical metrics by at least a preconfigured threshold amount. This may correspond, in some embodiments, to a “bootstrap” method, as described herein.

In some embodiments, the management node 19 is further configured to perform a second anomaly detection on the first dataset (e.g., using a different machine learning model than used for the first anomaly detection). The management node 19 is further configured to determine a weighted sum of at least one first error metric of the first anomaly detection, and at least one second error metric second anomaly detection. The management node 19 is further configured to (optionally) cause a rollback of the first network node 16 from the second software version to the first software version based on the weighted sum being greater than a first preconfigured threshold. This may correspond, in some embodiments, to an “ensemble” method, as described herein.

Having described the general process flow of arrangements of the disclosure and having provided examples of hardware and software arrangements for implementing the processes and functions of the disclosure, the sections below provide details and examples of arrangements for supporting an AI-based canary judge process for a canary deployment process in a RAN, such as a cloud RAN.

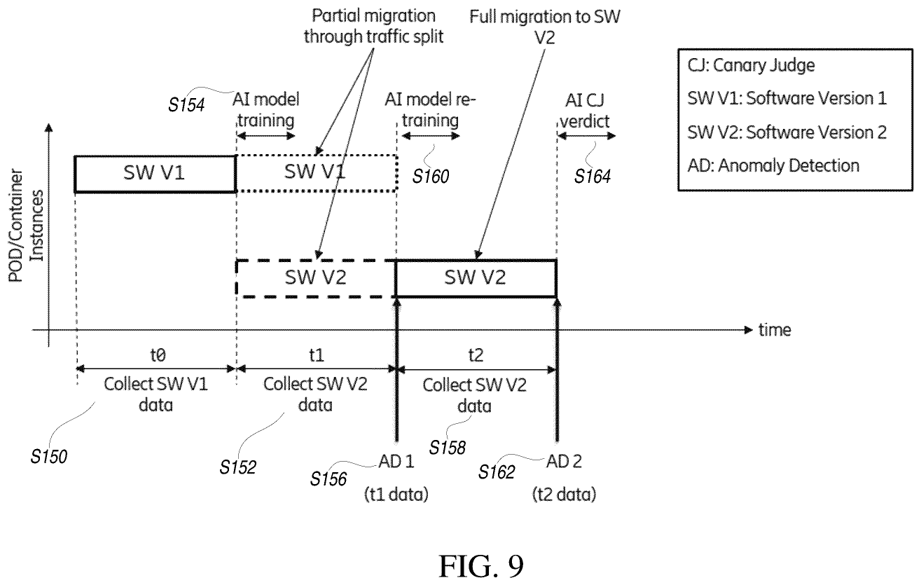

Embodiments of the present disclosure may support configurations for an AI-based canary judge method, system, and/or apparatus which evaluates the health/success/error rate/etc. of a software deployment, e.g., a deployment of a cloud RAN software release/update/etc. FIG. 9 is a timing diagram illustrating an example configuration according to some embodiments of the present disclosure. In this example, a software update triggers a canary deployment process, in which an attempt is made to migrate a system/network/set of nodes/etc. from Software version 1 (SW V1) to Software version 2 (SW V2), with migration/deployment being conditioned on there being no abnormality in the operation of the system running software V2.

In conventional system upgrades, for example, a manual test engineer may be tasked with monitoring the operation of the system running SW V2 to identify the success or failure of the migration process.

In embodiments of the present disclosure, by comparison, an AI-based canary judge process may include autonomously performing monitoring and/or analysis of several PMs and KPIs to assess the performance of the system (e.g., a plurality of network nodes 16 and/or other entities in a communication system 10, access network 12, core network 14, etc.) running SW V2 and identify a success or failure of the deployment process. A deployment process may include, e.g., a management node 19 configuring (e.g., using processing circuitry 98, deployment unit 32, etc.) a subset of network nodes 16 in a communication system 10 with an upgrade/modification/etc., e.g., from SW V1 to SW V2, and determining, using one or more of the techniques described herein, whether the upgrade was successful, for example, by using anomaly detection and/or AI-based determinations (e.g., using machine learning). In some embodiments, a “success verdict” may refer to a complete and/or successful migration, e.g., from SW V1 to SW V2, whereas a “failure verdict” may refer to an unsuccessful or incomplete migration, and may trigger a rollback operation to SW V1.

In a cloud RAN, for example, a set of PMs may be received, determined, and/or used (e.g., by management node 19) to evaluate the operation of a software update (e.g., measuring MAC downlink/uplink throughput, RACH success rate, etc., for one or more network nodes 16). PMs may include, for example, one or more KPIs, PM counters, PM events, trace logs, etc. In some embodiments, a three-phase deployment may be configured in a management node 19, as shown in the example of FIG. 9. A time t0 (Step S150), the communication system 10 is in a “normal” (e.g., error free, anomaly free, an acceptably low level of errors/anomalies, etc.) operation corresponding to a stable software release (i.e., SW V1). The management node 19 may be configured to collect data (e.g., PMs) associated with operation of the system 10 during this phase, and may store the data, e.g., in memory 102, in a cloud database, in a network node 16, etc. At time t1 (Step S152), the traffic is partially split between SW V1 and V2, for example, because half of network nodes 16 in the system 10 have been configured (e.g., by management node 19) with the stable software release SW V1 and the other half of network nodes 16 are configured with the updated software release SW V2. While the traffic is split (and/or at some other timing), the management node performs model training (Step S154), e.g., training a machine learning model and/or neural network, using the data corresponding to the normal operation. An anomaly detection (AD) is performed at Step S156. Based on the results of the AD at Step S156, at time t2, a full migration of the traffic to SW V2 may be performed (Step S158). The AI model(s) may be re-trained subsequent to the full migration (Step S160). A second AD may be performed (at the management node 19) subsequent to the full migration (Step S162), resulting in a verdict decision by the management node 19 (Step S164) regarding whether migration was successful or not. In other words, PM data may be collected and stored during each phase. This data may be used to train/re-train the AI model(s).

The verdict decision in the example of FIG. 9 may be based on two-step judge process (i.e., Anomaly Detection (AD) 1 and AD 2 in the figure). However, the process may be generalized according to the split considered (e.g., one-step judge of AD 1, two-step judge of AD 1 and AD2, or more).

In the example two-step judge process, the first step (Step S156) is performed at the end of t1 and the second step (Step S162) is performed at the end of t2. If AD 1 fails, a failure verdict triggers a rollback process to SW V1. Otherwise, the judge continues with AD 2. In this example, a successful migration requires success in both AD 1 and AD 2, whereas a failure requires only unsuccessful AD 1 or AD 2.

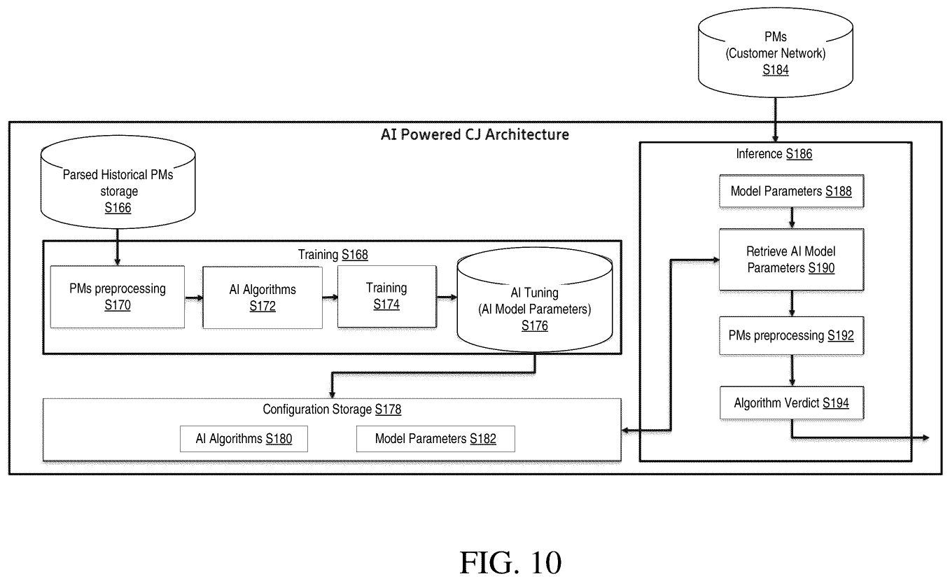

FIG. 10 is an example architecture and process flow for an AI-based canary judge process for both training and inference, e.g., in a management node 19, according to some embodiments of the present disclosure. Historical PMs (e.g., corresponding to error-free operation of a system 10) are collected, parsed, and stored, e.g., in a cloud database accessible by management node 19 (Step S166). During a training phase (Step S168), the PMs are collected from a customer network (e.g., one or more of communication system 10, access network 12, core network 14, etc.), parsed, and preprocessed (Step S170) (e.g., by management node 19) to fit the input of the AI algorithm(s) (Step S172), e.g., an LSTM autoencoder. In some embodiments, the collection process of the PMs may be performed “offline,” as it may involve the collection of data over a long time scale, such as several months, for a set of network nodes 16 (e.g., a set of gNBs). The training (Step S174) and tuning (Step S176) operations may be performed by management node 19, after which the model parameters may be stored by management node 19 in a “Configuration Storage” (Step S178), which stores AI algorithms (Step S180) and/or model parameters (Step S182).

PMs may be collected and stored (Step S184) corresponding to a customer network, e.g., PMs for a plurality of network nodes 16 of which at least some network nodes 16 have undergone a software update. During inference (Step S186), the various parameters (Step S188) (i.e., model parameters and/or canary judge parameters) may be retrieved (Step S190), e.g., through a “Config Handler” implemented by management node 19 and/or deployment unit 32. The collected PMs may be preprocessed (Step S192). An “Algorithm Verdict” step or module (e.g., implemented by management node 19, processing circuitry 98, deployment unit 32, etc.) utilizes the AI model to produce a verdict (Step S194).

In some embodiments, the preprocessing steps performed by management node 19 may differ between a training phase and an inference phase, and may utilize one or more of the following processes and configurations:

### Preprocessing for Training

1. Feature engineering: In some embodiments, a correlation analysis may be performed (e.g., by management node 19) to identify a set of PMs that will be used as input to the autoencoder. For example, a Pearson correlation matrix may be constructed among the input PMs, and a correlation threshold may be configured for selecting the final set of PMs for providing the AI model. This process may aid in reducing the dimensionality of the input and therefore the complexity and/or computational requirements of the AI model.

2. Data normalization: In some embodiments, the input sequence (e.g., of PMs) may be standardized by management node 19 using a Min-Max scaler, for example, which may combat bias in model fitting. Other data normalization or standardization techniques may be used without deviating from the scope of the present disclosure.

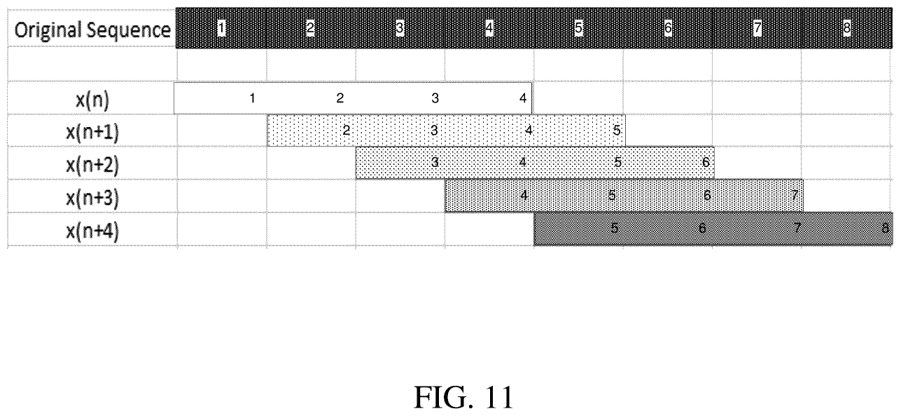

3. Windowing: In some embodiments, the input PMs may be represented by a multi-variate sequence x(t), where t represents a sequence sample (i.e., one timestamp). In some embodiments, this sequence may be transformed (e.g., by management node 19) into a time series format which includes a group of windows. Each window may have a fixed length (w) of sequence samples. The window may be moved each time by one sample. FIG. 11 is a timing diagram which illustrates an example time series with 8 samples (i.e., the original sequence). The original sequence is transformed into a set of windows, each with a size of 4 samples. In some embodiments of the present disclosure, the window size may be used (e.g., by management node 19) as a hyperparameter that may be tuned based on anomalies introduced in the input PMs. The window size may be optimized to achieve the lowest F1-score, for example. Other optimization and hyperparameter techniques may be used without deviating from the scope of the present disclosure.

### Preprocessing for Inference

During inference, the same or similar preprocessing steps (e.g., as described above with respect to training) may be performed. In some embodiments, feature engineering may differ in the case of inference as compared to training. For example, the feature engineering process during training may define the set(s) of PMs that should be used during inference, which may be stored (e.g., in memory 102) as a parameter, e.g., in a “Config Handler” module or unit (e.g., in deployment unit 32, as implemented in processing circuitry 98 of management node 19, etc.). In some embodiments, one or more stored parameters which were stored during the training phase may be retrieved may be retrieved and sued during the inference phase.

### Embodiment 1 (LSTM-based Autoencoder for Anomaly and Segment Detection)

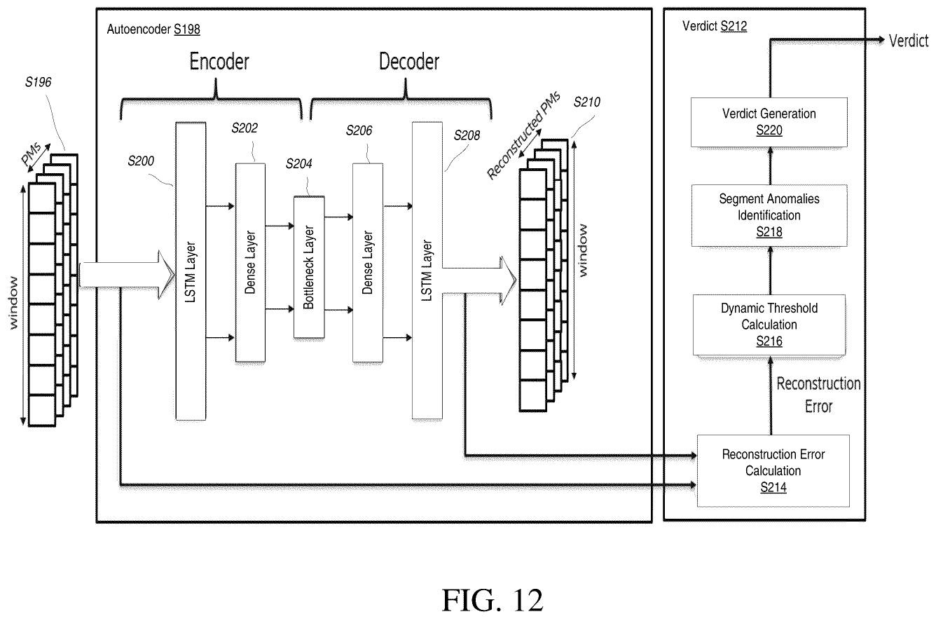

In some embodiments, an LSTM-based autoencoder may be employed (e.g., in deployment unit 32 of management node 19) that performs an anomaly detection process on input PMs associated with network nodes 16 in a communication system 10. FIG. 12 illustrates an example architecture and process flow for an autoencoder including a verdict generation process, according to some embodiments of the present disclosure. The input to the autoencoder in this example includes time series PMs, structured as windowed sequences, for example. An LSTM may be well-suited for time series sequences as it may be configurable for learning long-term dependencies in the input time series. In addition, an LSTM may solve the vanishing gradient problem which arises in some modeling scenarios, e.g., through the specific cell structure of the LSTM.

In some embodiments, an autoencoder, for example, may be configured for learning a representation (i.e., encoding) of the input PMs, such that it may be configured to extract significant information and discards insignificant information in the input sequence. In the example of FIG. 12, the PMs are input (Step S196) into the autoencoder (Step S198), which may be implemented, e.g., in a management node 19 processing circuitry 98. The autoencoder process includes an encoder portion and a decoder portion. The encoder portion may include one or more layers, e.g., an LSTM Layer (Step S200), a Dense Layer (Step S202), and a bottleneck layer (Step S204). Other layers and ordering of layers may be used without deviating from the scope of the present disclosure.

The decoding phase aims to reconstruct the input PMs, which typically involves or introduces some distortion (i.e., reconstruction error). The example of FIG. 12 represents an unsupervised approach, where the autoencoder is trained to reconstruct the “good” (e.g., significant) input PMs. Anomalies may be detected based on, e.g., the management node 19 observing a high reconstruction error in the autoencoder process.

The decoder portion may include the bottleneck layer (Step S204), which may be considered part of either or both of the encoder and decoder, a dense layer (Step S206), and an LSTM Layer (Step S208). Other layers and ordering of layers may be used without deviating from the scope of the present disclosure. The output of the final layer of the decoder (e.g., the LSTM Layer in Step S206) may include reconstructed PMs (Step S210), which may be organized in a similar configuration as the input PMs. The output of the final layer is also provided to the verdict process (Step S212). The verdict process includes a reconstruction error calculation process (Step S214), which receives the output of the final layer of the decoder (Step S206) and may also receive the input PMs (Step S196). The reconstruction error calculation (Step S214) produces a reconstruction error, which may be provided to a dynamic threshold calculation (Step S216), in some embodiments. The reconstruction error is compared with one or more dynamic thresholds, and the results are provided to the segment anomalies identification process (Step S218), which identifies anomalous segments, e.g., in the data. The result is provided to the verdict generation process (Step S220), which determines a verdict of whether a partial or complete migration from a first software version to a second software version was successful, or a failure (and therefore requires triggering a rollback).

For example, the verdict generation process may include a reconstruction error calculation, a dynamic threshold calculation, a detection of segment anomalies, and a verdict generation. After receiving a reconstruction error, a threshold may be used to identify anomalies. A dynamic threshold may be used to identify point anomalies. Samples with values greater than the dynamic threshold may be identified as anomalies.

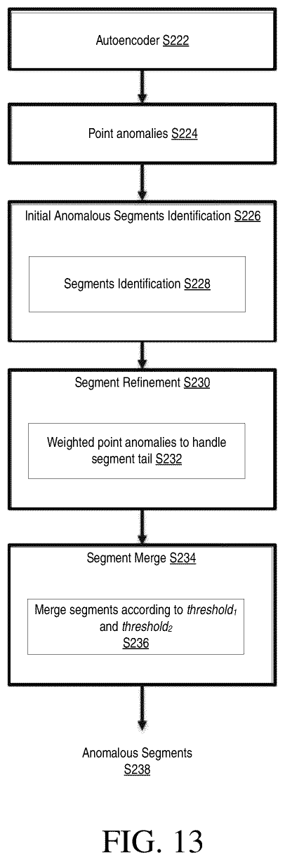

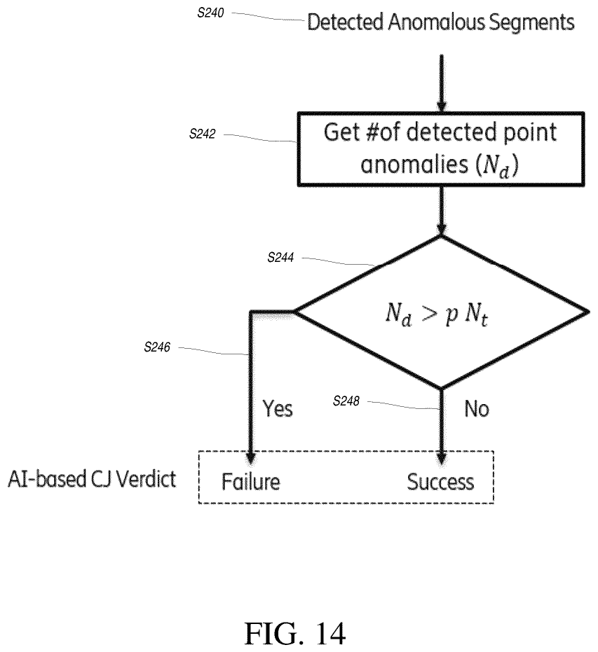

RAN PMs (e.g., downlink/uplink throughput, etc.) may be considered time series sequences, where it is more likely that they experience segment anomalies (i.e., consecutive sequence of point anomalies). Therefore, segment anomalies identification may be needed. FIG. 13 illustrates an example approach used (e.g., by management node 19 processing circuitry 98) to identify anomalous segments, according to some embodiments of the present disclosure. In some embodiments, an autoencoder (Step S222) may be used to generate/determine point anomalies (Step S224). An example approach may use one or more steps for determining segment anomalies: initial segments identification (Step S226), segments identification (Step S228), segment refinement (Step S230), weighted point anomalies to handle segment tails (Step S232), segments merge (Step S234), such as by merging segments according to threshold1 and threshold2 (Step S236), to determine/identify/generate one or more anomalous segments (Step S238). In initial segments identification, a segment may be identified by consecutive point anomalies. However, the autoencoder may produce false alarms (i.e., false positive point anomalies). Therefore, the management node 19 may be configured to perform a segment refinement process, e.g., to allocate weights to different point anomalies in a segment. For example, segments which are in close proximity may be merged to form bigger segments. This process may be used for reducing the likelihood of mis-detected point anomalies. The merging process may be based on, e.g., the number of point anomalies between the two segments under consideration. The following rule may be used, for example, to compute a threshold for deciding whether to merge two segments:

$${threshold}_{1} = {p}_{1} \times size of the small segment ,$$

$${threshold}_{2} = {p}_{2} \times size of the large segment ,$$

$$if {threshold}_{2} = min ( {threshold}_{2} , 2 \times size of the small segment ) ,$$

$$Merge segments if : number of anomalies in between < min ( {threshold}_{1} , {threshold}_{2} ) ,$$

where p₁ and p₂ are parameters to control the percentages for the thresholds. The segment identification process may be applied to each PM in addition to the final sequence.

Isolated point anomalies may be treated in two ways. First, an isolated point anomaly may be discarded, e.g., if it constitutes low priority. Second, an isolated point anomaly may be allocated to a low-weight segment, where different segments can have different contribution (weights) in the final verdict generation/computation.

Finally, verdict generation may be performed to flag success or failure of the software release (e.g., SW V2). FIG. 14 illustrates an example process flow, e.g., as implemented in management node 19, for a verdict calculation process where the number of point anomalies are computed from the detected and refined anomalous segments. The detected anomalous segments (Step S240) are analyzed to determine the number of detected point anomalies, e.g., in each segment, in one or more segments, etc. (Step S242). The percentage of detected anomalies is compared with a threshold (Step S244). A failure verdict is generated if the percentage of detected anomalies exceed a certain threshold p (Step S246), otherwise a success verdict is generated (Step S248).

### Model Tuning/Training

### Section I: Global Model Training Methods

In some embodiments, a management node 19 may be configured for a canary deploying in a cloud RAN, and thus may utilize cloud RAN PMs to analyze whether the deployment was successful. In some embodiments, a generalization process may be needed to maintain portability of various models across network nodes 16 (e.g., gNBs). Various methods may be used for global model training. The collected PMs may be grouped per network node 16 (e.g., gNB), for example.

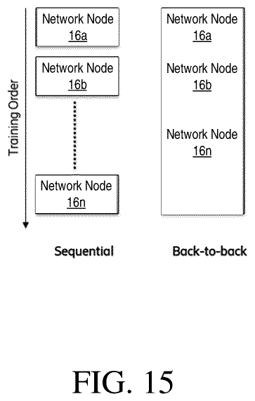

FIG. 15 is a diagram which illustrates two example training methods according to some embodiments of the present disclosure in a system 10 including a plurality of network nodes 16, e.g., as implemented in management node 19.

Sequential training: This may be performed by sequentially training the model on the PMs of each network node 16 (e.g., gNB).

Back-to-back training: The PMs of all network nodes 16 (e.g., gNBs) are concatenated, e.g., by appending one after the end of another. Then the model may be trained with all the data.

### Section II: Window Size Tuning

The tuning of the autoencoder involves the optimization of both the window size and the model parameters. Window size tuning is performed by iteratively introducing several sequences of anomalous PMs and selecting the window size with the lowest F1-score. Furthermore, typical hyperparameter tuning is performed.

### Embodiment 2 (LSTM-based Forecasting)

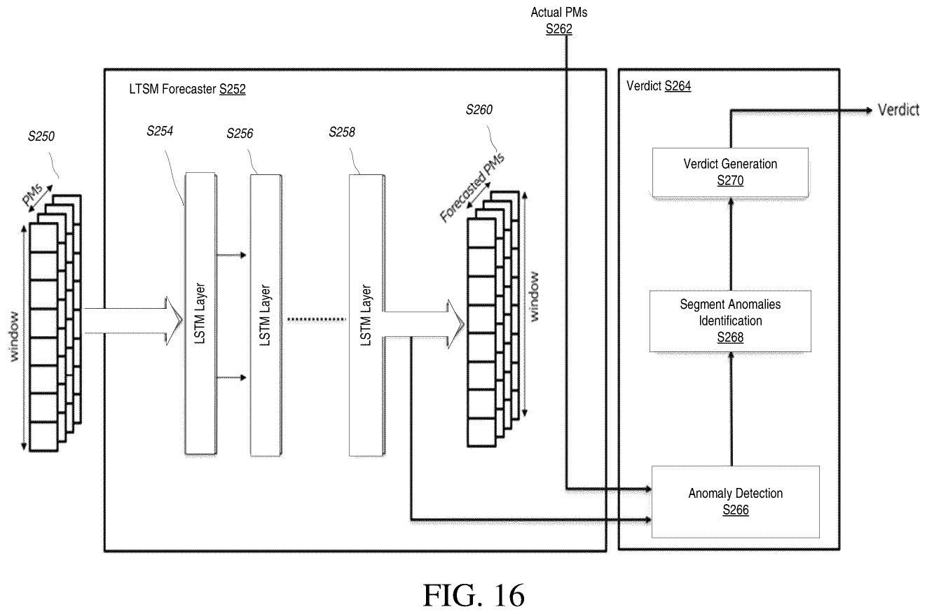

In some embodiments, an LSTM-based forecaster may be used by management node 19 to perform forecasting for the PMs of SW V2. FIG. 16 is a diagram which illustrates an architecture and process flow of a forecaster, e.g., an LSTM forecaster implemented in one or more of a management node 19, processing circuitry 98, deployment unit 32, etc., according to some embodiments of the present disclosure. Similar to the autoencoder described above, the forecaster in the example of FIG. 16 accepts multi-variate time series PMs, and the training may be performed in an unsupervised approach (i.e., only non-anomalous PMs may be used).

For example, referring to the embodiment shown in FIG. 16, a windowed dataset of PMs (Step S250) is received by the LTSM Forecaster (Step S252) in a management node 19, which includes a first LSTM Layer (Step S254), a one or more additional LSTM Layers (Step S256), and a final LSTM Layer (Step S258), which generates/determines/computes/outputs a set of windowed forecasted PMs (Step S260). Other layers and ordering of layers may be used without deviating from the scope of the present disclosure. The outputs forecasted PMs and the actual PMs (Step S262) are provided to the verdict process (Step S264), which includes an anomaly detection (Step S266), which detects anomalies using the forecasted PMs and the actual PMs, a segment anomalies identification (Step S268), and a verdict generation (Step S270) process.

The training of the forecaster by the management node 19 may be performed offline, e.g., using the global model approach discussed in the previous embodiment with respect to a plurality of network nodes 16. At the end of t0, the forecaster is retrained using PMs collected from SW V1. This ensures the alignment of the AI model with any drift in the data (i.e., concept drift).

Referring again to the timing diagram of FIG. 9, in some embodiments, such as Embodiment 2, the canary judge process may include the management node 19 performing two decisions at the end of t1 and t2. In t1, the forecaster may use a sliding window of observed PMs to forecast one sample ahead. At the end of t1, the forecasted PMs, along with the observed PMs during t1, may be fed into an anomaly detection method to identify point anomalies, which may be performed by a variety of anomaly detection techniques (e.g., autoencoder, statistical method, etc.), as described herein. Segment identification and verdict generation may be similar to the approaches described with respect to Embodiment 1. A similar procedure may be repeated for t2.

### Embodiment 3 (Bootstrap)

In some embodiments, a Bootstrap solution may be used by management node 19 to perform statistical analyses of the distribution of the PMs at both the training and testing phases, e.g., of a machine learning model, a statistical model, an AI model, etc. The deviation of the statistical metrics may be used by management node 19 to flag success or failure of the software upgrade process.

Referring again to FIG. 9, in some embodiments, a Bootstrap method (e.g., implemented by a management node 19) may include training of a statistical model using statistical metrics of SW V1 PMs collected in t0 (i.e., mean, variance, etc). Then, the metrics of SW V2 PMs collected during t1 may be inspected. A threshold value may be used to identify the success or failure of the migration process. In some embodiments, this approach may be applied to each PM separately, such that a second level of decision-making may be triggered to perform the verdict generation.

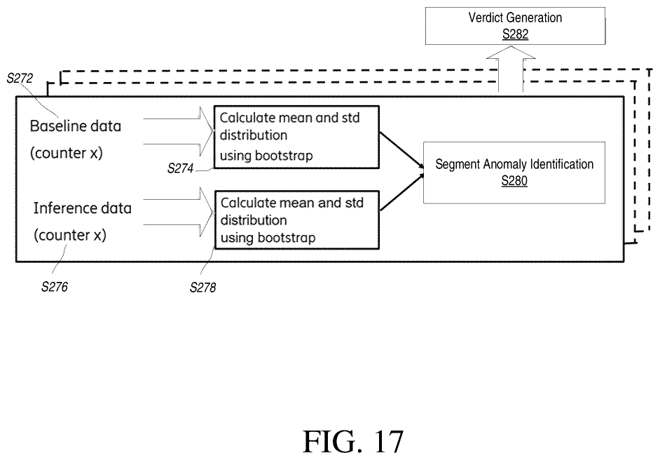

FIG. 17 illustrates an example architecture and process flow for a Bootstrap method as implemented by a management node 19 according to some embodiments of the present disclosure. The management node 19 receives baseline data (Step S272) and calculates (Step S274) mean and standard distribution thereof. The management node 19 receives inference data (Step S276) and calculates (Step S278) the mean and standard distribution thereof. The management node utilizes the calculations from Step S274 and Step S278 to perform segment anomaly identification (Step S280), which is used to generate a verdict (Step S282), as described herein.

### Embodiment 4 (Ensemble Method)

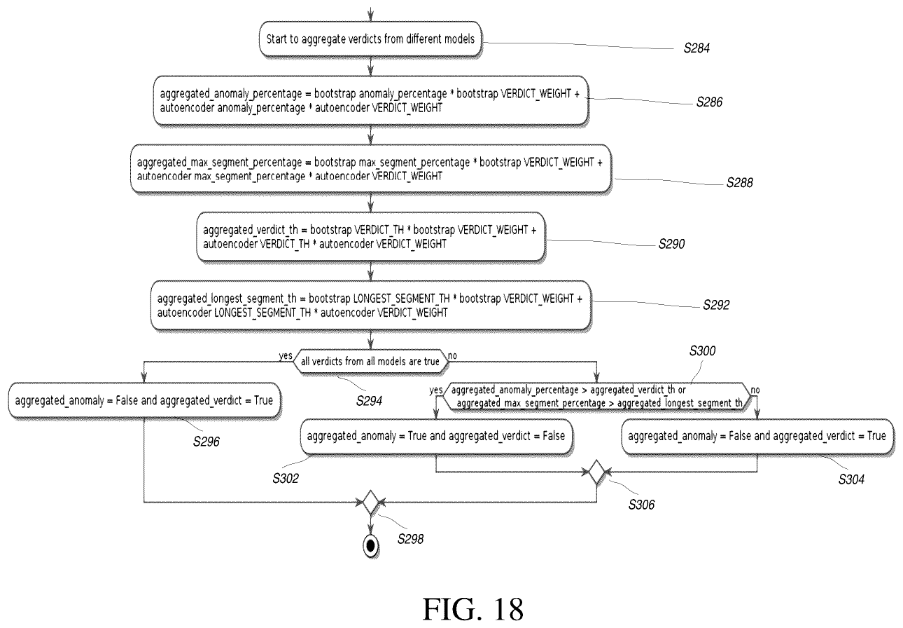

In some embodiments, management node 19 may utilize an aggregation process of the verdicts of one or more anomaly detection approaches (i.e., an ensemble method). FIG. 18 is a flowchart which illustrates an example embodiment applied to an autoencoder process and a bootstrap process, as implemented by a management node 19. The proposed methods return set of metrics, exemplified in the figure as anomaly percentage and maximum segment percentage. Each metric has a corresponding aggregate metric that is calculated as a weighted some of the individual metrics from the methods. The final verdict, hence, is decided based on whether the metrics exceeds a certain threshold. For example, a final failure verdict is generated if aggregate anomaly percentage exceeds a specific threshold and maximum segment length exceeds another threshold.

Referring to FIG. 18, in Step S284, the management node 19 starts to aggregate verdicts from various different models. In Step S286, the management node 19 determines an aggregated anomaly percentage, which may be a weighted sum of the verdicts of the component methods (bootstrap and autoencoder). In Step S288, the management node 19 determines an aggregated maximum segment percentage, which may be a weighted sum of the maximum segment percentages of the component methods. In Step S290, the management node 19 calculates an aggregated verdict value. In Step S292, the management node 19 calculates an aggregated longest segment value. In Step S294, the management node 19 determines if all of the verdicts from all models are true. If yes, then in Step S296, the management node 19 sets an aggregated anomaly value to “True”, which is output at Step S298, e.g., for additional processes related to deployment/rollback of software updates. If the result of Step S294 is a “No”, then at Step S300, the management node 19 determines whether the aggregated anomaly percentage is greater than an aggregated verdict value (e.g., a threshold value) and/or determines whether the aggregated maximum segment percentage is greater than an aggregated longest segment value (e.g., a threshold value). If “Yes”, then at Step S302, the management node 19 sets the aggregated anomaly value to “False”. If “No”, then the management node sets the aggregated anomaly value to “True.” The output of either Step S302 or Step S304 is output (Step S306 and Step S298).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AI Artificial Intelligence
CJ Canary Judge
CRAN Cloud RAN
LSTM Long Short-term Memory
PM Performance Metric
RAN Radio Access Network
SW Software

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A management node for a wireless communication network, the wireless communication network comprising a plurality of network nodes, the management node comprising processing circuitry configured to:
train a machine learning model using a historical dataset of performance metrics associated with at least one network node configured with at least one software version of a plurality of software versions, the historical dataset of performance metrics being associated with a non-anomalous state of the at least one network node;
receive a first dataset of performance metrics associated with a first network node configured with a second software version of the plurality of software versions which is an update of a first software version of the plurality of software versions; and
perform a first anomaly detection on the first dataset of performance metrics using the trained machine learning model to determine a number of anomalies of the first dataset of performance metrics.

2. The management node of claim 1, wherein the processing circuitry is further configured to perform the first anomaly detection by:
determining a plurality of point anomalies associated with the first set of performance metrics;
grouping at least a portion of the plurality of point anomalies into a plurality of corresponding segments; and
determining, for the plurality of point anomalies, a corresponding plurality of weight values based on the plurality of corresponding anomaly segments; and
determining the number of anomalies of the first dataset of performance metrics based on the plurality of point anomalies and the corresponding plurality of weight values.

3. The management node of claim 2, wherein the processing circuitry is further configured to determine the corresponding plurality of weight values by:
assigning a first weight value to point anomalies belonging to a first corresponding segment which has fewer than a threshold number of point anomalies belonging to the first corresponding segment; and
assigning a second weight value to point anomalies belonging to a second corresponding segment which has greater than the threshold number of point anomalies belonging to the second corresponding segment.

4. The management node of claim 3, wherein the first weight value is 0.

5. The management node of claim 1, wherein the processing circuitry is further configured to one of:
cause a rollback of the first network node from the second software version to the first software version based on the first number of anomalies being greater than a first preconfigured threshold; and
cause migration of at least one additional network node from the first software version to the second software version based on the first number of anomalies being below the first preconfigured threshold.

6. The management node of claim 5, wherein the processing circuitry is further configured to:
responsive to causing migration of the at least one additional network node to the second software version, receive an additional dataset of performance metrics associated with the at least one additional network node;
perform a second anomaly detection on the additional dataset of performance metrics using the machine learning model; and
one of:
optionally, cause migration of a remainder of the plurality of network nodes from the first software version to the second software version responsive to the second anomaly detection detecting a second number of anomalies below a second preconfigured anomaly threshold; and
optionally, cause a rollback of the at least one additional network node and the first network node from the second software version to the first software version based on the second number of anomalies being above the second preconfigured anomaly threshold.

7. The management node of claim 1, wherein the first software version and second software version correspond to versions of baseband software.

8. The management node of claim 1 wherein the processing circuitry is further configured to train the machine learning model by:
determining a plurality of performance metric types of the historical dataset of performance metrics;
determining at least one statistical correlation between at least one pair of the plurality of performance metric types based on the historical dataset of performance metrics;
determining a subset of the plurality of performance metric types based on the at least one statistical correlation exceeding a preconfigured correlation threshold; and
training the machine learning model using the subset of the plurality of performance metric types as a plurality of features.

9. The management node of claim 8, wherein the processing circuitry is further configured to perform the first anomaly detection on the first set of performance metrics using the trained machine learning model based on the subset of the plurality of performance metric types from the first dataset of performance metrics.

10. The management node of claim 1, wherein the machine learning model includes a Long Short-term Memory autoencoder; and
the processing circuitry is further configured to perform the first anomaly detection by:
encoding the first dataset of performance metrics using the LSTM autoencoder;
decoding the first dataset of performance metrics using the LSTM autoencoder to determine a reconstruction error metric; and
detecting at least one anomaly associated with the first dataset based on the reconstruction error metric exceeding a preconfigured threshold.

11. The management node of claim 1, wherein the processing circuitry is further configured to perform the first anomaly detection by:
determining a predicted dataset of performance metrics using the machine learning model based on the historical dataset of performance metrics; and
detecting the first number of anomalies of the first dataset of performance metrics based on the first dataset of performance metrics deviating from the predicted dataset of performance metrics by at least a preconfigured threshold.

12. The management node of claim 1, wherein the processing circuitry is further configured to perform the first anomaly detection by:
determining an historical set of statistical metrics associated with the historical dataset;
determining a first set of statistical metrics associated with the first dataset; and
determining the number of anomalies based on the first set of statistical metrics deviating from the historical set of statistical metrics by at least a preconfigured threshold amount.

13. The management node of claim 1, wherein the processing circuitry is further configured to:
perform a second anomaly detection on the first dataset;
determine a weighted sum of at least one first error metric of the first anomaly detection and at least one second error metric second anomaly detection; and
cause a rollback of the first network node from the second software version to the first software version based on the weighted sum being greater than a first preconfigured threshold.

14. A method implemented in a management node for a wireless communication network, the wireless communication network comprising a plurality of network nodes, the method comprising:
training a machine learning model using a historical dataset of performance metrics associated with at least one network node configured with at least one software version of a plurality of software versions, the historical dataset of performance metrics being associated with a non-anomalous state of the at least one network node;
receiving a first dataset of performance metrics associated with a first network node configured with a second software version of the plurality of software versions which is an update of a first software version of the plurality of software versions; and
performing a first anomaly detection on the first dataset of performance metrics using the trained machine learning model to determine a number of anomalies of the first dataset of performance metrics.

15. The method of claim 14, wherein the method further comprises performing the first anomaly detection by:
determining a plurality of point anomalies associated with the first set of performance metrics;
grouping at least a portion of the plurality of point anomalies into a plurality of corresponding segments; and
determining, for the plurality of point anomalies, a corresponding plurality of weight values based on the plurality of corresponding anomaly segments; and
determining the number of anomalies of the first dataset of performance metrics based on the plurality of point anomalies and the corresponding plurality of weight values.

16. The method of claim 15, wherein the method further comprises determining the corresponding plurality of weight values by:
assigning a first weight value to point anomalies belonging to a first corresponding segment which has fewer than a threshold number of point anomalies belonging to the first corresponding segment; and
assigning a second weight value to point anomalies belonging to a second corresponding segment which has greater than the threshold number of point anomalies belonging to the second corresponding segment.

17. The method of claim 16, wherein the first weight value is 0.

18. The method of claim 14, wherein the method further comprises at least one of:
causing a rollback of the first network node from the second software version to the first software version based on the first number of anomalies being greater than a first preconfigured threshold; and
causing migration of at least one additional network node from the first software version to the second software version based on the first number of anomalies being below the first preconfigured threshold.

19. The method of claim 18, wherein the method further comprises:
responsive to causing migration of the at least one additional network node to the second software version, receiving an additional dataset of performance metrics associated with the at least one additional network node;
performing a second anomaly detection on the additional dataset of performance metrics using the machine learning model; and
one of:
causing migration of a remainder of the plurality of network nodes from the first software version to the second software version responsive to the second anomaly detection detecting a second number of anomalies below a second preconfigured anomaly threshold; and
causing a rollback of the at least one additional network node and the first network node from the second software version to the first software version based on the second number of anomalies being above the second preconfigured anomaly threshold.

20-39. (canceled)

40. A method implemented in a wireless communication system comprising at least one management node and a plurality of network nodes, the method comprising:
in at least one network node of the plurality of network nodes:
determining at least one performance metric associated with the at least one network node; and
causing transmission of an indication of the at least one performance metric to a management node; and
in the management node:
training a machine learning model using a historical dataset of performance metrics associated with at least one network node configured with at least one software version of a plurality of software versions, the historical dataset of performance metrics being associated with a non-anomalous state of the at least one network node;
receiving a first dataset of performance metrics associated with a first network node configured with a second software version of the plurality of software versions which is an update of a first software version of the plurality of software versions; and
performing a first anomaly detection on the first dataset of performance metrics using the trained machine learning model to determine a number of anomalies of the first dataset of performance metrics.

41-52. (canceled)
